(19) United States
(12) Patent Application Publication
(10) Pub. No.: US 2013/0106324 A1
(43) Pub. Date: May 2, 2013

(54) MOTOR DRIVING APPARATUS

(71) Applicant: Joo Yul KO, Hwaseong (KR)

(72) Inventor: Joo Yul KO, Hwaseong (KR)

(73) Assignee: SAMSUNG ELECTRO-MECHANICS CO., LTD.

(21) Appl. No.: 13/362,706

(22) Filed: Jan. 31, 2012

(30) Foreign Application Priority Data
Nov. 2, 2011 (KR) 10-2011-0113359

(51) Int. Cl. H02P 6/08

(52) U.S. Cl. 318/400.3

(57) ABSTRACT

There is provided a motor driving apparatus in which when a voltage level of external power is lower than a reference voltage level, a voltage level boosted by a separately provided direct current (DC) to DC converter is selected and supplied to field effect transistors (FETs), such that driving of a motor does not stop even in the case in which the voltage level of the external power is lowered. The motor driving apparatus includes: a power selecting unit selecting one of a preset first power, and a second power having a voltage level different from that of the first power, according to a detected motor driving voltage signal; and a driving unit driving the motor by receiving the power selected by the power selecting unit; and a driving controlling unit providing driving signals for driving the driving unit.

### CROSS-REFERENCE TO RELATED APPLICATIONS

This application claims the priority of Korean Patent Application No. 10-2011-0113359 filed on Nov. 2, 2011 in the Korean Intellectual Property Office, the disclosure of which is incorporated herein by reference.

### BACKGROUND OF THE INVENTION

1. Field of the Invention

The present invention relates to a motor driving apparatus driving a motor through the application of external power.

2. Description of the Related Art

A brushless direct current (BLDC) motor generally refers to a DC motor having a function of changing a conducting current or adjusting a current direction using a non-contact position detector and a semiconductor element, rather than using a mechanical contact such as a brush, a commutator, or the like, in a DC motor.

In order to drive this BLCD motor, a driving apparatus may be used.

FIG. 1 is a configuration diagram of a general motor driving apparatus.

Referring to FIG. 1, the general motor driving apparatus may include a driving unit 40 having a plurality of field effect transistors (FETs) switched by receiving external power 10, a pulse width modulation (PWM) controller 20 providing PWM signals controlling the plurality of FETs of the driving unit 40 according to PWM signals from the outside, and a gate driver 30 providing driving signals driving the plurality of FETs according to the PWM signals of the PWM controller 20.

However, in the case of this general motor driving apparatus, when a voltage level of the external power is at a preset voltage level or less, driving of the motor may be stopped.

### SUMMARY OF THE INVENTION

An aspect of the present invention provides a motor driving apparatus in which, when a voltage level of external power is lower than a reference voltage level, a voltage level boosted by a separately provided direct current (DC) to DC converter is selected and supplied to field effect transistors (FETs), such that driving of a motor is continuous, even in a case in which the voltage level of the external power is lowered.

According to an aspect of the present invention, there is provided a motor driving apparatus including: a power selecting unit selecting one of a preset first power, and a second power having a voltage level different from that of the first power, according to a detected motor driving voltage signal; a driving unit driving the motor by receiving the power selected by the power selecting unit; and a driving controlling unit providing driving signals for driving the driving unit.

The power selecting unit may include: a first comparator comparing a voltage level of the detected motor driving voltage signal with a preset reference voltage; a reference voltage generator providing the reference voltage; and a first switch selecting the first power or the second power, according to a comparison result of the first comparator, to thereby provide the selected power to the driving unit.

The reference voltage generator may include: a second comparator comparing a duty of the driving signal with a preset reference duty; and a second switch proving one of a first reference voltage and a second reference voltage, each having a different voltage level, to the first comparator, according to a comparison result of the second comparator.

The motor driving apparatus may further include a direct current (DC) to DC converter converting the voltage level of the first power to thereby supply the second power.

The motor driving apparatus may further include a voltage sensing unit detecting voltage used by the driving unit for driving the motor to thereby provide the detected motor driving voltage signal to the power selecting unit.

The driving controlling unit may include: a pulse width modulation (PWM) controller providing PWM control signals having a duty set according to external control signals; and a gate driver converting the PWM control signals into the driving signals capable of driving the driving unit, providing the converted driving signal.

The driving unit may include: a first PMOS FET electrically connected between a power supply terminal through which the power from the power selecting unit is supplied and a ground; a first NMOS FET electrically connected between the first PMOS FET and the ground; a second PMOS FET connected to the power supply terminal in parallel with the first PMOS FET, and electrically connected between the power supply terminal and the ground; and a second NMOS FET electrically connected between the second PMOS FET and the ground.

According to another aspect of the present invention, there is provided a motor driving apparatus including: a power selecting unit selecting one of a preset first power, and a second power obtained by boosting the first power; a driving unit driving a motor by receiving the power selected by the power selecting unit; and a driving controlling unit providing driving signals for driving the driving unit.

The power selecting unit may include: a first comparator comparing a voltage level of a detected motor driving voltage signal with a preset reference voltage; a reference voltage generator providing the reference voltage; and a first switch selecting the first power or the second power, according to a comparison result of the first comparator, to thereby provide the selected power to the driving unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram of a general motor driving apparatus;

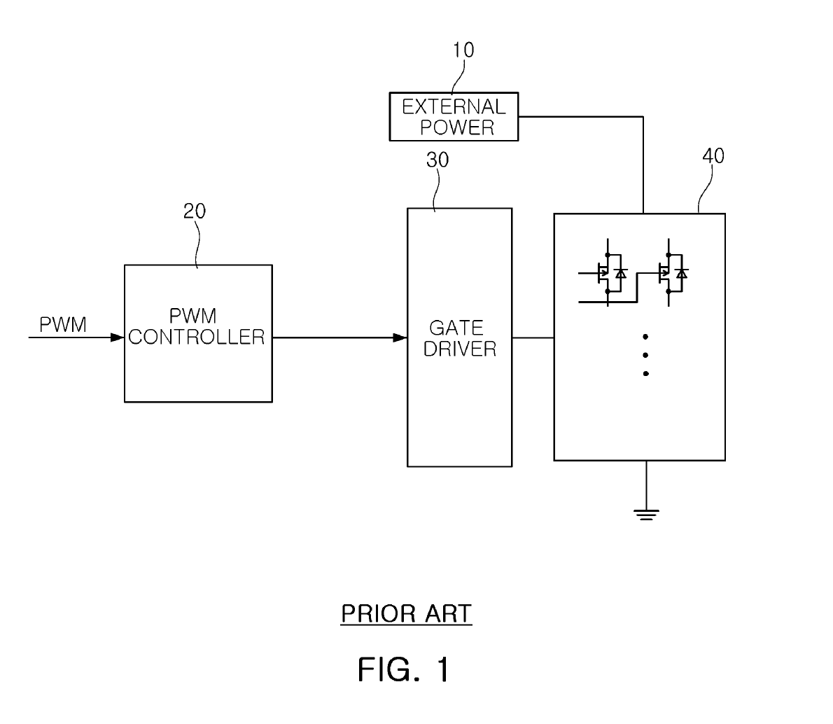

FIG. 2 is a configuration diagram of a motor driving apparatus according to an embodiment of the present invention;

FIG. 3 is a timing chart of driving signals provided by the motor driving apparatus according to the embodiment of the present invention;

FIG. 4 is a configuration diagram of a power selecting unit used in the motor driving apparatus according to the embodiment of the present invention; and

FIG. 5 is a configuration diagram of a reference voltage generator used in the power selecting unit of FIG. 4.

### DETAILED DESCRIPTION OF THE INVENTION

Hereinafter, embodiments will be described in detail with reference to the accompanying drawings so that they can be easily practiced by those skilled in the art to which the present invention pertains.

However, in describing embodiments of the present invention, detailed descriptions of well-known functions or constructions will be omitted so as not to obscure the description of the present invention with unnecessary detail.

In addition, like or similar reference numerals denote parts performing similar functions and actions throughout the drawings.

A case in which any one part is connected with the other part includes a case in which the parts are directly connected with each other and a case in which the parts are indirectly connected with each other with other elements interposed therebetween.

In addition, unless explicitly described otherwise, “comprising” any components will be understood to imply the inclusion of other components but not the exclusion of any other components.

Embodiments of the present invention will now be described in detail with reference to the accompanying drawings.

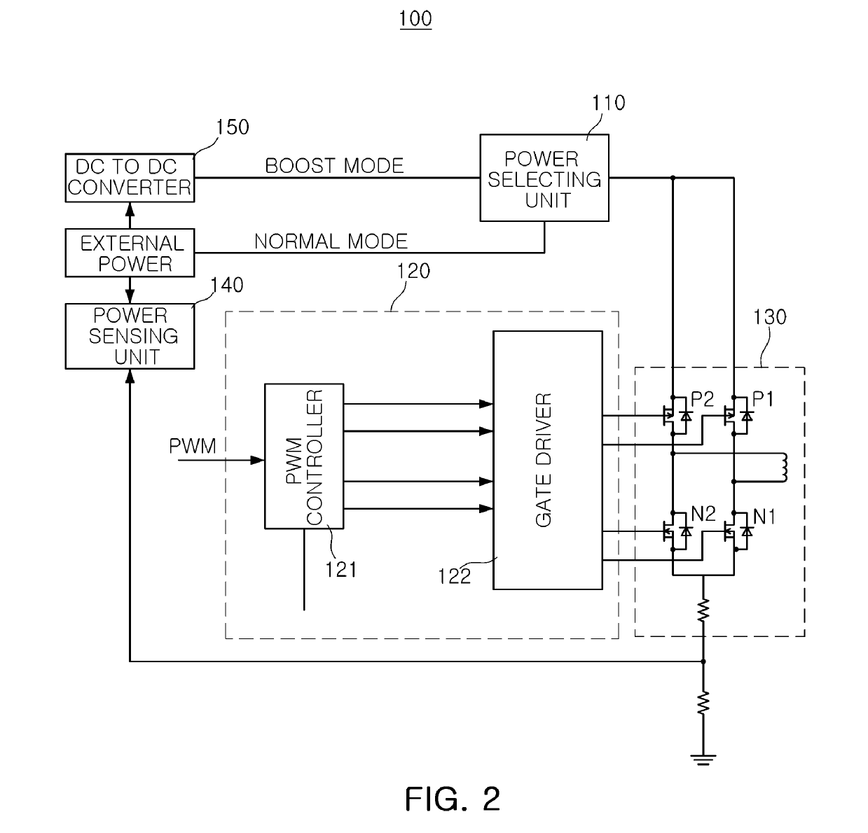

FIG. 2 is a configuration diagram of a motor driving apparatus according to an embodiment of the present invention.

Referring to FIG. 2, the motor driving apparatus 100 according to the embodiment of the present invention may include a power selecting unit 110, a driving controlling unit 120, and a driving unit 130.

In addition, the motor driving apparatus 100 according to the embodiment of the present invention may further include a power sensing unit 140 and a direct current (DC) to DC converter 150.

The power selecting unit 110 may select a first power preset and applied from the outside or a second power different from the first power to thereby transfer the selected power to the driving unit 130.

The first power transferred to the power selecting unit 110 may be operation power supplied from the outside, and the second power may be a power having a voltage level set to be different from that of the first power.

More specifically, the second power may have a voltage level higher than that of the first power.

In addition, the second power may be obtained by boosting the first power.

To this end, the DC to DC converter 150 may convert the voltage level of the first power, to thereby provide the second power having the voltage level boosted as compared to the voltage level of the first power, to the power selecting unit 110.

In a case in which the first power is transferred to the power selecting unit 110, it may be regarded as a bypass mode, and in a case in which the second power is transferred thereto, it may be regarded as a boost mode.

The driving controlling unit 120 may provide driving signals driving the driving unit 130 according to control signals from the outside.

To this end, the driving controlling unit 120 may include a pulse width modulation (PWM) controller 121 and a gate driver 122.

The PWM controller 121 may provide PWM control signals having a duty varied according to the control signals from the outside to the gate driver 122.

The gate driver 122 may convert the PWM controlling signals from the PWM controller 121 into driving signals capable of driving field effect transistors (FETs) of the driving unit 130 to thereby control driving of the driving unit 130.

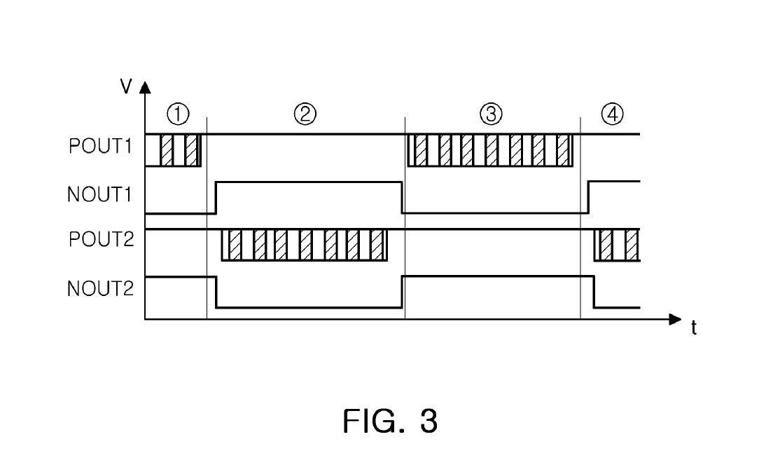

FIG. 3 is a timing chart of driving signals provided by the motor driving apparatus according to the embodiment of the present invention;

Referring to FIGS. 2 and 3, the driving unit 130 may include a total of four switches, wherein the four switches may be formed of two P-channel metal oxide semiconductor field effect transistors (PMOS FETs) P1 and P2 and two N-channel metal oxide semiconductor field effect transistors (NMOS FETs) N1 and N2.

A first PMOS FET P1 may be electrically connected between a power supply terminal through which the power from the power selecting unit 110 is supplied and a ground, and a first NMOS FET N1 may be electrically connected between the first PMOS FET P1 and the ground.

A second PMOS FET P2 may be connected to the power supply terminal in parallel with the first PMOS FET P1 and be electrically connected between the power supply terminal and the ground, and a second NMOS FET N2 may be electrically connected between the second PMOS FET P2 and the ground.

The driving signals transferred from the driving controlling unit 120 to the driving unit 130 may be divided into four kinds and be transferred in a sequence of identification numbers \textcircled{1}, \textcircled{2}, \textcircled{3}, and \textcircled{4}.

That is, a first PMOS FET P1 and a second NMOS FET N2 may be turned on by a driving signal represented by the identification numeral \textcircled{1}, and the first PMOS FET P1 and the second NMOS FET N2 may be turned off and a second PMOS FET P2 and a first NMOS FET N1 may be turned on by a driving signal represented by the identification numeral \textcircled{2}.

Again, the second PMOS FET P2 and the first NMOS FET N1 may be turned off and the first PMOS FET P1 and the second NMOS FET N2 may be turned on by a driving signal represented by the identification numeral \textcircled{3}, and the first PMOS FET P1 and the second NMOS FET N2 may be turned off and the second PMOS FET P2 and the first NMOS FET N1 may be turned on by a driving signal represented by the identification numeral \textcircled{4}.

In this driving scheme, when the first PMOS FET P1 and the second PMOS FET P2 are turned on, the PWM signals (oblique line portions of FIG. 3) are generated, whereby a speed of the motor may be controlled.

As described above, the first PMOS FET P1 and the second NMOS FET N2, and the second PMOS FET P2 and the first NMOS FET N1, are alternately turned on and off to form a path through which current flows, whereby the motor may be driven.

The power sensing unit 140 may detect power used for driving the motor to thereby transfer a detected signal to the power selecting unit 110.

That is, the power sensing unit 140 may detect the power used for driving the motor by receiving voltage divided from a resistor that may be provided between sources of the first and second NMOS FETs N1 and N2 of the driving unit 130 and the ground.

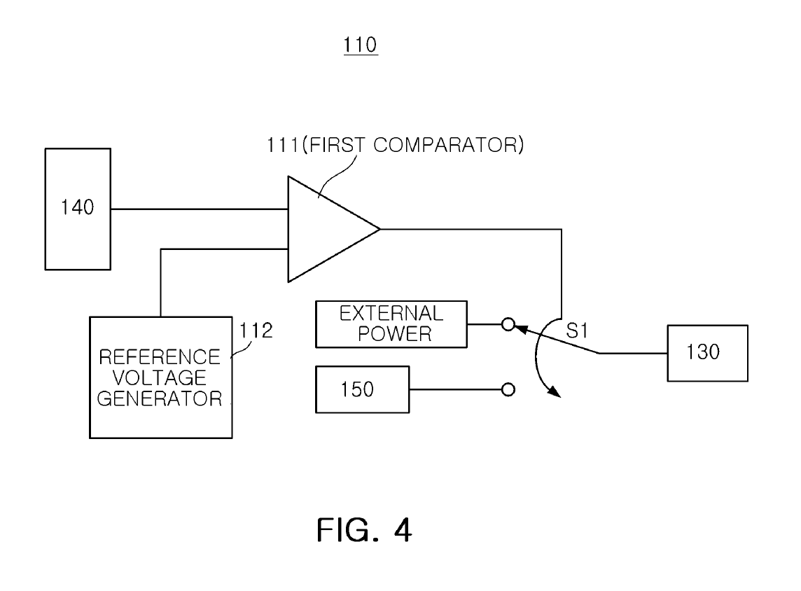

FIG. 4 is a configuration diagram of a power selecting unit used in the motor driving apparatus according to the embodiment of the present invention.

Referring to FIG. 4, the power selecting unit 110 may include a first comparator 111 and a reference voltage generator 112.

The first comparator 111 may compare a voltage level of the detected signal from the power sensing unit 140 with a reference voltage from the reference voltage generator 112 to thereby transfer the comparison result to a first switch S1.

The first switch S1 may select one of the first power, which is the external power, and the second power from the DC to DC converter 150 according to the comparison result from the first comparator 111 to thereby transfer the selected power to the driving unit 130.

More specifically, the first switch S1 may select and transfer the first power to the driving unit 130 in a case in which the voltage level of the detected signal is higher than the reference voltage, and select and transfer the second power having the voltage level higher than that of the first power to the driving unit 130 in the case in which the voltage level of the detected signal is lower than the reference voltage.

Meanwhile, a voltage level of the above-mentioned reference voltage may be changed into a first reference voltage or a second reference voltage according to whether the power transferred to the driving unit 130 is the first power or the second power.

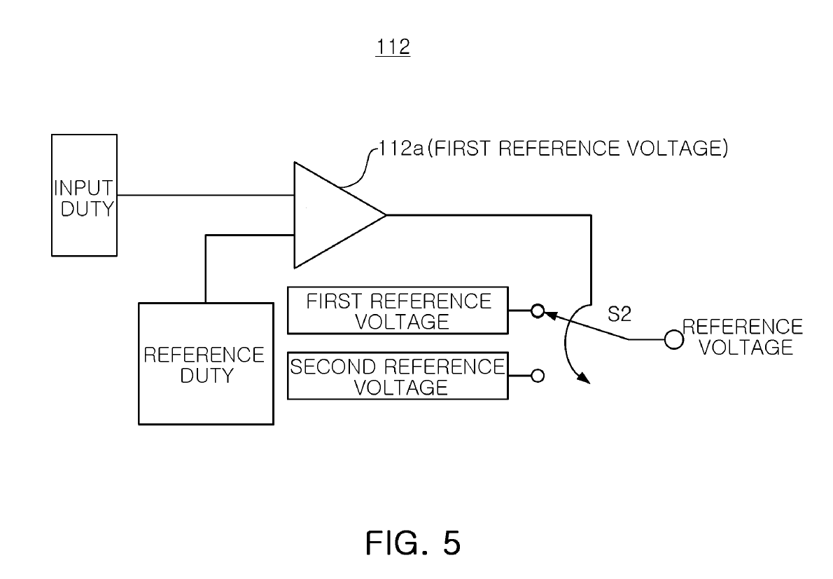

FIG. 5 is a configuration diagram of a reference voltage generator used in the power selecting unit of FIG. 4.

Referring to FIG. 5, the reference voltage generator 112 may include a second comparator 112a and a second switch S2.

The second comparator 112a may compare an input duty with a preset reference duty to thereby transfer the comparison result to the second switch S2, and the second switch S2 may select one of a first reference voltage and a second reference voltage set to have a voltage level higher than that of the first reference voltage to thereby provide the selected reference voltage as the reference voltage to the first comparator 111.

As set forth above, according to the embodiments of the present invention, when the voltage level of the external power is higher than the reference voltage level, the motor is continuously driven, and when the voltage level of the external power is lower than the reference voltage level, the voltage level boosted by the separately provided DC to DC converter may be selected and supplied to the FETs for driving the motor, such that driving of a motor is continuous even in the case in which the voltage level of the external power is lowered, whereby the motor may be continuously driven.

While the present invention has been shown and described in connection with the embodiments, it will be apparent to those skilled in the art that modifications and variations can be made without departing from the spirit and scope of the invention as defined by the appended claims.

What is claimed is:

1. A motor driving apparatus comprising:
a power selecting unit selecting one of a preset first power, and a second power having a voltage level different from that of the first power according to a detected motor driving voltage signal;
a driving unit driving the motor by receiving the power selected by the power selecting unit; and
a driving controlling unit providing driving signals for driving the driving unit.

2. The motor driving apparatus of claim 1, wherein the power selecting unit includes:
a first comparator comparing a voltage level of the detected motor driving voltage signal with a preset reference voltage;
a reference voltage generator providing the reference voltage; and
a first switch selecting the first power or the second power, according to a comparison result of the first comparator, to thereby provide the selected power to the driving unit.

3. The motor driving apparatus of claim 2, wherein the reference voltage generator includes:
a second comparator comparing a duty of the driving signal with a preset reference duty; and
a second switch proving one of a first reference voltage and a second reference voltage, each having a different voltage level, to the first comparator according to a comparison result of the second comparator.

4. The motor driving apparatus of claim 1, further comprising a direct current (DC) to DC converter converting the voltage level of the first power to thereby supply the second power.

5. The motor driving apparatus of claim 1, further comprising a voltage sensing unit detecting voltage used by the driving unit for driving the motor to thereby provide the detected motor driving voltage signal to the power selecting unit.

6. The motor driving apparatus of claim 1, wherein the driving controlling unit includes:
a pulse width modulation (PWM) controller providing PWM control signals having a duty set according to external control signals; and
a gate driver converting the PWM control signals into the driving signals capable of driving the driving unit, and providing the converted driving signal.

7. The motor driving apparatus of claim 1, wherein the driving unit includes:
a first P-channel metal oxide semiconductor field effect transistor (PMOS FET) electrically connected between a power supply terminal through which the power from the power selecting unit is supplied and a ground;
a first N-channel metal oxide semiconductor field effect transistor (NMOS FET) electrically connected between the first PMOS FET and the ground;
a second PMOS FET connected to the power supply terminal in parallel with the first PMOS FET, and electrically connected between the power supply terminal and the ground; and
a second NMOS FET electrically connected between the second PMOS FET and the ground.

8. A motor driving apparatus comprising:
a power selecting unit selecting one of a preset first power, and a second power obtained by boosting the first power;
a driving unit driving a motor by receiving the power selected by the power selecting unit; and
a driving controlling unit providing driving signals for driving the driving unit.

9. The motor driving apparatus of claim 8, wherein the power selecting unit includes:
a first comparator comparing a voltage level of a detected motor driving voltage signal with a preset reference voltage;
a reference voltage generator providing the reference voltage; and
a first switch selecting the first power or the second power, according to a comparison result of the first comparator, to thereby provide the selected power to the driving unit.

10. The motor driving apparatus of claim 8, wherein the reference voltage generator includes:
a second comparator comparing a duty of the driving signal with a preset reference duty; and
a second switch proving one of a first reference voltage and a second reference voltage, each having a different voltage level, to the first comparator, according to a comparison result of the second comparator.

11. The motor driving apparatus of claim 8, further comprising a DC to DC converter boosting a voltage level of the first power to thereby supply the second power.

12. The motor driving apparatus of claim 8, further comprising a voltage sensing unit detecting voltage used by the driving unit for driving the motor to thereby provide the detected voltage to the power selecting unit.

13. The motor driving apparatus of claim 8, wherein the driving controlling unit includes:
a pulse width modulation (PWM) controller providing PWM control signals having a duty set according to external control signals; and
a gate driver converting the PWM control signals into the driving signals capable of driving the driving unit, and providing the converted driving signal.

14. The motor driving apparatus of claim 8, wherein the driving unit includes:
a first PMOS FET electrically connected between a power supply terminal through which the power from the power selecting unit is supplied and a ground;
a first NMOS FET electrically connected between the first PMOS FET and the ground;
a second PMOS FET connected to the power supply terminal in parallel with the first PMOS FET and electrically connected between the power supply terminal and the ground; and
a second NMOS FET electrically connected between the second PMOS FET and the ground.
